(19) United States
(12) Patent Application Publication
(10) Pub. No.: US 2008/0056317 A1
(43) Pub. Date: Mar. 6, 2008

(54) Laser Driver Circuit and Optical Disc Apparatus Having the Laser Driver Circuit

(75) Inventors: Shinichiro Saito, Yokosuka-shi (JP); Kazuto Kuroda, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/848,170

(22) Filed: Aug. 30, 2007

(30) Foreign Application Priority Data
Aug. 30, 2006 (JP) 2006-233428

(51) Int. Cl. H01S 3/00

(52) U.S. Cl. 372/38.02

(57) ABSTRACT

To improve a recording speed and an optical waveform quality while lower power consumption in the laser driver circuit is achieved. In an optical disc apparatus including a laser driver circuit according to the present invention, a laser diode emits a laser light a power supply regulator supplies a predetermined power supply voltage to the laser driver circuit, a control micro computer performs a control to switch the predetermined power supply voltage supplied from the power supply regulator to the laser driver circuit in accordance with a recording time or a reproduction time.

### CROSS-REFERENCE TO RELATED APPLICATIONS

This application is based upon and claims the benefit of priority from Japanese Patent Application No. 2006-233428, filed Aug. 30, 2006, the entire contents of which are incorporated herein by reference.

### BACKGROUND OF THE INVENTION

1. Field of the Invention

The present invention relates to a laser driver circuit and an optical disc apparatus having the laser driver circuit. In particular, the invention relates to a laser driver circuit in which a power supply voltage of the laser driver circuit can be switched and an optical disc apparatus having the laser driver circuit.

2. Description of the Related Art

In general, in an optical disc apparatus represented by a high speed DVD (Digital Versatile Disc) recording drive and an HD-DVD recording drive using blue LD (Laser diode), a laser drive voltage supplied to a laser diode constituting an optical pickup is large for ensuring a laser power necessary for recording. Thus, a power supply voltage supplied to a laser drive circuit for driving the laser diode (light emitting unit) is set high in these days.

In addition, in the laser drive circuit of the optical disc apparatus, with use of a power supply regulator having a function of keeping the voltage constant, the drive voltage supplied (applied) to the laser diode and a power supply voltage supplied to a laser diode driver (laser driver IC) are kept constant all the time.

On the other hand, a technology for switching the power supply voltage in an APC circuit supplied to the laser diode driver (laser driver IC) is proposed (for example, refer to Japanese Unexamined Patent Application Publication No. 2000-323783).

According to the technology proposed in Japanese Unexamined Patent Application Publication No. 2000-323783, in a laser power control circuit, on the basis of a laser power detection signal and a reference signal, a DC/DC conversion is performed on the power supply voltage but not on an operational voltage to generate a laser drive voltage. Thus, it is possible to reduce an electric power loss at the time of generating the laser drive voltage.

In general, in the laser diode, a higher output power (laser power) is required during the recording than during the reproduction. When a comparison is made, the highest output power (laser power) during the recording may be more than 50 times higher than that during the reproduction in some cases.

For example, in an optical disc apparatus using a red laser diode, a current exceeding 500 mA at highest during the recording flows into the laser diode. On the other hand, during the reproduction, a current of approximately only 100 mA flows into the laser diode. As a result, as a resistance component exists in the laser diode, the laser drive voltage necessary for the laser diode varies, for example, by about 3 V between during the recording and during the reproduction.

However, as described above, in the laser driver circuit, with use of the power supply regulator, the drive voltage supplied (applied) to the laser diode and the power supply voltage supplied to the laser diode driver (laser driver IC) are kept constant all the time. During the reproduction, an excess current which does not contribute to the light emission of the laser diode driver (for example, a current of the remaining 350 mA calculated by subtracting 100 mA from 450 mA) therefore exists, the current is consumed as a wasteful thermal energy in the laser diode driver.

Of course, if the technology proposed in Japanese Unexamined Patent Application Publication No. 2000-323783 is used, it is also possible to switch the power supply voltage supplied to the laser diode driver (laser driver IC). However, the switching is performed in the APC circuit, and therefore the responsiveness for the switching is not satisfactory and the switching is unpractical. Thus, the above-mentioned problem cannot be solved.

In an optical disc apparatus using a blue laser diode which has been developed in recent years, a resistance component of the blue laser diode is larger than those of the red laser diode or an infra-red laser diode, and accordingly the wastefully consumed current in the laser diode driver is thought to be increased.

In addition, recently, an optical disc apparatus capable of performing the recording and reproduction has been mounted to a laptop personal computer and the like. For that reason, lower power consumption in the optical disc apparatus is much demanded. It is assumed that the laptop personal computer is placed in a high temperature environment under sun light or the like, and heat generation in such a high temperature environment may lead to a danger of ignition or the like.

On the other hand, in recent years, high speed recording has been generalized and at the time of driving the laser diode, a high output power and a high optical waveform quality (such as short rising time) have been required. In particular, this optical waveform quality tends to be higher as a difference between the laser drive voltage supplied to the laser diode and the power supply voltage supplied from the power supply regulator to the laser diode driver or the like becomes larger. In view of the above, in general, the power supply voltage supplied from the power supply regulator is previously set higher in order to maintain the high recording speed and the high optical waveform quality, but in this case, the wasteful power consumption gets higher in the laser diode driver.

### SUMMARY OF THE INVENTION

The present invention has been made in view of the above-mentioned circumstances and an object of the present invention is to provide a laser driver circuit in which a recording speed and an optical waveform quality can be improved while lower power consumption is achieved in the laser driver circuit and an optical disc apparatus including the laser driver circuit.

In order to solve the above-mentioned problem, a laser driver circuit according to an aspect of the present invention includes a light emitting unit configured to emit a laser light; a voltage supply unit configured to supply a predetermined power supply voltage to the laser driver circuit; and a control unit configured to perform a control so as to switch the predetermined power supply voltage supplied from the voltage supply unit to the laser driver circuit in accordance with to one of a recording time and a reproduction time during recording or during reproduction.

In order to solve the above-mentioned problem, an optical disc apparatus includes a laser driver circuit according to an aspect of the present invention, the laser driver circuit including a light emitting unit configured to emit a laser light; a voltage supply unit configured to supply a predetermined power supply voltage to the laser driver circuit; and a control unit configured to perform a control so as to switch the predetermined power supply voltage supplied from the voltage supply unit to the laser driver circuit in accordance with to one of a recording time and a reproduction time.

According to the laser driver circuit of the present invention, the laser light is emitted, the predetermined power supply voltage is supplied to the laser driver circuit, and in accordance with to one of a recording time and a reproduction time, the control is performed so as to switch the predetermined power supply voltage supplied to the laser driver circuit.

According to the optical disc apparatus including the laser driver circuit of the present invention, the laser light is emitted, the predetermined power supply voltage is supplied to the laser driver circuit, and in accordance with to one of a recording time and a reproduction time, the control is performed so as to switch the predetermined power supply voltage supplied to the laser driver circuit.

### BRIEF DESCRIPTION OF THE DRAWINGS

In the accompanying drawings:

FIG. 1 is a block diagram illustrating an internal configuration of an optical disc apparatus according to an embodiment of the present invention;

FIG. 2 illustrates an internal circuit configuration of a laser driver circuit of the optical disc apparatus illustrated in FIG. 1;

FIG. 3 is a flowchart for describing a power supply voltage switching control process in the laser driver circuit of FIG. 2;

FIG. 4 is a flowchart for describing another power supply voltage switching control process in the laser driver circuit of FIG. 2;

FIG. 5 illustrates another internal circuit configuration of the laser driver circuit of the optical disc apparatus illustrated in FIG. 1;

FIG. 6 illustrates still another internal circuit configuration of the laser driver circuit of the optical disc apparatus illustrated in FIG. 1; and

FIGS. 7A and 7B illustrate further internal circuit configurations of the laser driver circuit of FIG. 1.

### DESCRIPTION OF THE PREFERRED EMBODIMENTS

Hereinafter, a description will be given of embodiments of the present invention with reference to the drawings.

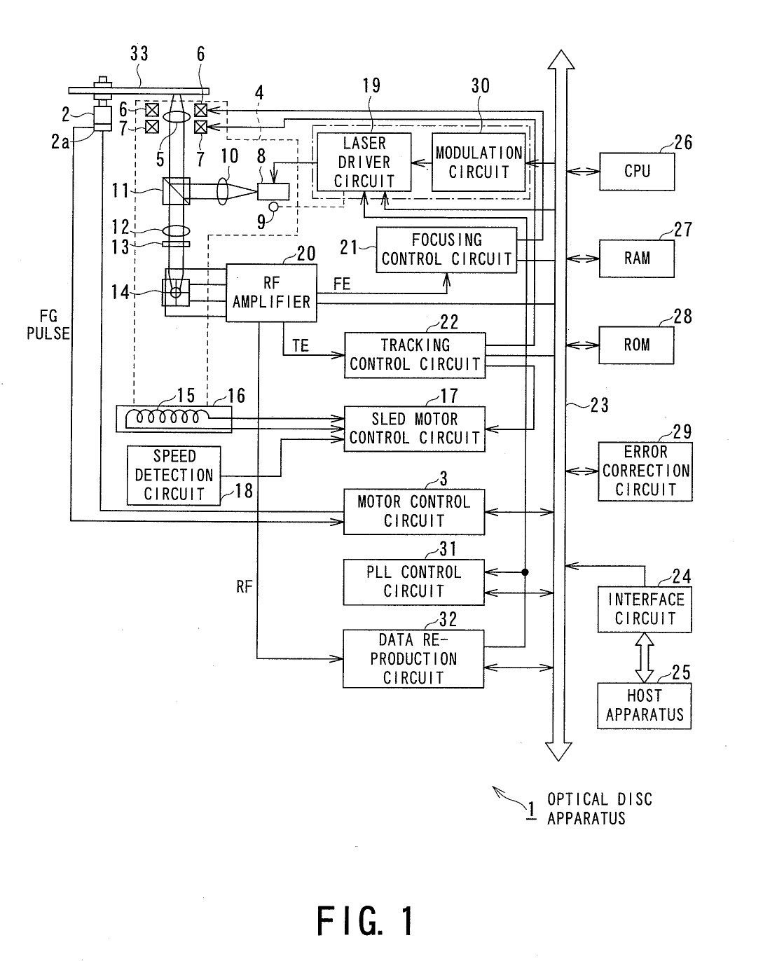

FIG. 1 illustrates an internal configuration of an optical disc apparatus according to an embodiment of the present invention.

As illustrated in FIG. 1, the optical disc apparatus 1 is provided with a spindle motor 2. The spindle motor 2 outputs an FG pulse (rotational angle signal) for controlling the number of rotations of an optical disc 33 to a motor control circuit 3 from a rotary encoder 2a attached to the spindle motor 2. On the basis of the FG pulse input from the rotary encoder 2a, the motor control circuit 3 determines the number of rotations of the spindle motor 2 and performs a control so as to keep the predetermined number of rotations set in advance. In accordance with the control of the motor control circuit 3, the spindle motor 2 rotates the optical disc 33 at a predetermined angular rate.

Then, the optical disc apparatus 1 performs information recording and reproduction with respect to the optical disc 33 by using an optical pickup 4. The optical pickup 4 is composed of an objective lens 5, drive coils 6 and 7 for driving the objective lens 5, a laser diode 8, a photo diode 9 for a front monitor, a collimator lens 10, a deflection prism 11, a collective lens 12, a cylindrical lens 13, and a four-division optical detector 14. The optical pickup 4 irradiates the optical disc 33 with a laser light emitted from the laser diode 8.

The optical pickup 4 is coupled to a sled motor 15 via a gear not shown in the drawing, and the sled motor 15 is controlled by a sled motor control circuit 17. A speed detection circuit 18 for detecting the speed of the optical pickup 4 is connected to the sled motor control circuit 17. On the basis of a speed signal of the optical pickup 4 that is supplied from the speed detection circuit 18, the speed of the optical pickup 4 is controlled. A permanent magnet not shown in the drawing is provided to a fixed part of the sled motor 15. A drive coil 16 inside the sled motor 15 is excited by the sled motor control circuit 17 to cause the optical pickup 4 to move in a radius direction of the optical disc 33.

A laser driver circuit 19 obtains a laser power detection signal supplied from the photo diode 9 for the front monitor inside the optical pickup 4 and controls the power of the laser light emitted from the laser diode 8 on the basis of the thus obtained laser power detection signal. In particular, as will be described later, the power of the laser light is controlled at predetermined different levels depending on during the recording and during the reproduction.

The optical disc 33 is irradiated with the laser light emitted from the laser diode 8 via the collimator lens 10 of the optical pickup 4. The four-division optical detector 14 is irradiated with a reflection light from the optical disc 33 via the objective lens 5 inside the optical pickup 4, the deflection prism 11, the collective lens 12, and the cylindrical lens 13.

A detection signal of the four-division optical detector 14 is output to an RF amplifier 20 (including an equalizer). The RF amplifier 20 amplifies and shapes a detection signal input from the four-division optical detector 14 and respectively outputs a focus error signal (FE), a tracking error signal (TE), and a full addition signal of optical detection cell signals (RF) to a focusing control circuit 21, a tracking control circuit 22, and a data reproduction circuit 32.

In addition, the optical disc apparatus 1 is connected to a host apparatus 25 via an interface circuit 24. In accordance with a command supplied from the host apparatus 25 via the interface circuit 24, a CPU (Central Processing Unit) 26 executes various processes in accordance with various application programs loaded on a RAM (Random Access Memory) 27 from an application program stored in a ROM (Read Only Memory) 28 and generates various control signals to be supplied to the respective units, thus controlling the optical disc apparatus 1 in an overall manner. The RAM 28 appropriately stores necessary data for the CPU 26 to execute various processes. It should be noted that the CPU 26, the RAM 27, and the ROM 28 are mutually connected via a bus 23.

Furthermore, the optical disc apparatus 1 includes a buffer memory (not shown) necessary for continuously inputting data and discretely output the data or performing the operation in a reverse way, an error correction circuit 29 (including a modulator-demodulator) for performing an error correction by way of a signal process, and a modulation circuit 30 for performing a digital modulation.

Record data from the host apparatus 25 is supplied via the interface circuit 24 to the error correction circuit 29 and reproduction data output from the error correction circuit 29 is supplied via the interface circuit 24 to the host apparatus 25. In the error correction circuit 29, an error correction code addition process is performed on the record data and an error correction process is performed on the reproduction data on which a demodulation process has been performed in the data reproduction circuit 32.

The optical disc apparatus 1 further includes a PLL control circuit 31 (clock reproduction circuit) 31. A signal output from the RF amplifier 20 (a signal in which a frequency characteristic is compensated in the RF amplifier 20) is supplied to the PLL control circuit 31. The PLL control circuit 31 outputs a clock used when the reproduction data is reproduced. This clock is used as a system clock for a reproduction system circuit (for example, the data reproduction circuit 32 or the like).

The optical disc apparatus 1 has the above-mentioned configuration. In a writing mode, first, the record data is supplied from the host apparatus 25 via the interface circuit 24 and the bus 23 to the error correction circuit 29, the error correction code addition process is executed in the error correction circuit 29, and thereafter, the record data after the error correction code addition process is supplied to the modulation circuit 30 to execute the modulation process. Second, the record data supplied from the modulation circuit 30 after the modulation process is supplied to the laser driver circuit 19. As a result, the laser light emitted from the laser diode 8 of the optical pickup 4 is subjected to an optical intensity modulation in accordance with the record data, and the record data is optically recorded on a data unit (not shown) on the optical disc 33.

On the other hand, in a reading mode, first, the RF amplifier 20 supplies the signal output from the optical pickup 4 as the full addition signal (RF) to the data reproduction circuit 32 (including a demodulation circuit). In the demodulation circuit (not shown) of the data reproduction circuit 32, a demodulation process is executed and the full addition signal after the demodulation process is supplied to the error correction circuit 29. Second, in the error correction circuit 29, the error correction process is executed on the full addition signal after the demodulation process. Then, the reproduction data supplied from the error correction circuit 29 is supplied via the bus 23 and the interface circuit 24 to the host apparatus 25.

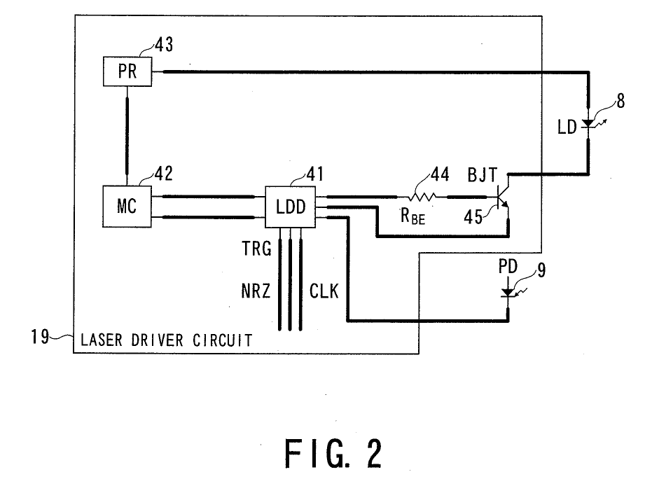

FIG. 2 illustrates an internal circuit configuration of the laser driver circuit 19 of FIG. 1.

As illustrated in FIG. 2, the laser driver circuit 19 is composed of a laser diode driver (LDD) 41, the control micro computer (MC) 42, a power supply regulator (PR) 43, a resistance (R_{BE}) 44, and a drive transistor (BJT) 45.

When the reading mode is set, the laser diode driver 41 obtains a system clock (CLK) supplied via the bus 23 and the modulation circuit 30, and a mode switching signal (TRG) for switching the mode into one of the reading mode and the writing mode. The laser diode driver 41 supplies the thus obtained mode switching signal (TRG) to the control micro computer 42.

On the basis of the mode switching signal supplied from the laser diode driver 41, the control micro computer 42 recognizes that the mode is switched from the writing mode to the reading mode. At the same time, as the laser power necessary for the reading mode is relatively lower than that in the writing mode, the control micro computer 42 generates a reading mode voltage switching control signal for supplying predetermined power supply voltage and laser drive voltage with which the laser light having the predetermined laser power is output from the laser diode 8 in the reading mode to the laser driver circuit 19 and the laser diode 8, and supplies the thus generated reading mode voltage switching control signal to the power supply regulator 43. On the basis of the reading mode voltage switching control signal supplied from the control micro computer 42, the power supply regulator 43 supplies the predetermined power supply voltage and laser drive voltage with which the laser light having the predetermined laser power is output from the laser diode 8 in the reading mode to the laser driver circuit 19 and the laser diode.

The laser diode driver 41 obtains the laser power detection signal supplied from the photo diode 9 and on the basis of the thus obtained laser power detection signal, controls the laser power of the laser light emitted from the laser diode 8 to be constant (APC control). Then, the power supply regulator 43 is composed of a voltage variable switching type DC-DC converter. The power supply regulator 43 depends on an output current but is subjected to a voltage adjustment with a small electric power loss in general (approximately its conversion efficiency is 90% or above).

On the other hand, when the writing mode is set, the laser diode driver 41 obtains the record data (NRZ: an NRZ modulation method), a system clock (CLK), and a mode switching signal (TRG) indicating whether the mode is switched to one of the reading mode and the writing mode or not supplied via the bus 23 and the modulation circuit 30 after the modulation process. The laser diode driver 41 supplies the thus obtained mode switching signal (TRG) to the control micro computer 42.

On the basis of the mode switching signal (TRG) supplied from the laser diode driver 41, the control micro computer 42 recognizes the mode is switched from the reading mode to the writing mode. At the same time, as the necessary laser power during writing mode is relatively higher than that in the reading mode, the control micro computer 42 generates a writing mode voltage switching control signal for supplying predetermined power supply voltage and laser drive voltage with which laser light having the predetermined laser power is output from the laser diode 8 in the writing mode to the laser driver circuit 19 and the laser diode 8, and supplies the thus generated writing mode voltage switching control signal to the power supply regulator 43. On the basis of the writing mode voltage switching control signal supplied from the control micro computer 42, the power supply regulator 43 supplies the predetermined power supply voltage and laser drive voltage with which laser light having the predetermined laser power is output from the laser diode 8 in the writing mode to the laser driver circuit 19 and the laser diode 8.

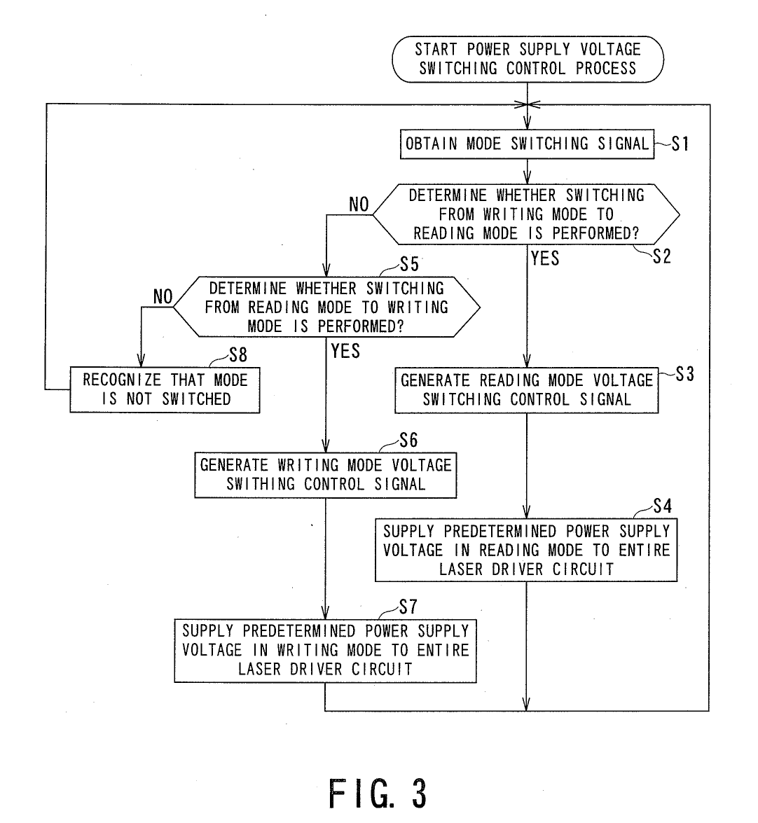

Next, with reference to a flowchart of FIG. 3, a power supply voltage switching control process in the laser driver circuit 19 of FIG. 2 will be described. It should be noted that this power supply voltage switching control process is started when a user operates an operation unit, which is not shown in the drawing, of the host apparatus 25 to instruct the switching into the reading mode or the writing mode.

In Step S1, the laser diode driver 41 obtains the system clock (CLK) and the mode switching signal (TRG) indicating whether the switching is performed into one of reading mode and the writing mode or not supplied via the bus 23 and the modulation circuit 30. During the writing mode, the laser diode driver 41 further obtains the record data (NRZ: the NRZ modulation method) supplied via the bus 23 and the modulation circuit 30 after the modulation process. The laser diode driver 41 supplies the thus obtained mode switching signal (TRG) to the control micro computer 42.

The control micro computer 42 obtains the mode switching signal supplied from the laser diode driver 41. This mode switching signal includes data indicating whether the mode instructed to be switched in response to the operation of the operation unit (not shown) of the host apparatus 25 by the user is the reading mode or the writing mode.

In Step S2, on the basis of the thus obtained mode switching signal, the control micro computer 42 determines whether the switching from the writing mode to the reading mode is performed or not. To be more specific, in a case where the current mode is the writing mode and also where the thus obtained mode switching signal includes data indicating that the mode instructed to be switched in response to the operation of the operation unit (not shown) of the host apparatus 25 by the user is the reading mode, it is determined that the switching from the writing mode to the reading mode is performed. On the other hand, in other cases, it is determined that the switching from the writing mode to the reading mode is not performed.

In Step S2, when it is determined that the switching from the writing mode to the reading mode is performed, the control micro computer 42 recognizes in Step S3 that the switching is performed from the writing mode that is the current mode to the reading mode. At the same time, as the laser power necessary for the reading mode is relatively lower than that in the writing mode, the control micro computer 42 generates a reading mode voltage switching control signal for supplying predetermined power supply voltage and laser drive voltage with which the laser light having the predetermined laser power is output from the laser diode 8 in the reading mode to the laser driver circuit 19 and the laser diode 8, and supplies the thus generated reading mode voltage switching control signal to the power supply regulator 43.

In Step S4, on the basis of the reading mode voltage switching control signal supplied from the control micro computer 42, the power supply regulator 43 supplies the predetermined power supply voltage and laser drive voltage with which the laser light having the predetermined laser power is output from the laser diode 8 in the reading mode to the laser driver circuit 19 and the laser diode 8. To be more specific, on the basis of the reading mode voltage switching control signal supplied from the control micro computer 42, the power supply regulator 43 decreases the power supply voltage to be output to the entirety of the laser driver circuit 19 which is set in the writing mode before the switching and also decreases the laser drive voltage to be applied to the laser diode 8. At the same time, the laser diode driver 41 decreases a base-emitter bias voltage of the drive transistor 45.

As a result, at the same time when the power supply voltage is switched from the writing mode to the reading mode in conjunction with the mode switching signal, the mode is shifted to the reading mode. During the reading mode (at the time of the reproduction), the excess current which does not contribute to the light emission of the laser diode 8 in the laser diode driver 41 is suppressed, and thus it is possible to suppress the wasteful thermal energy consumption in the laser diode driver 41. Therefore, it is possible to achieve the lower power consumption in the laser driver circuit 19.

After that, the process advances to Step S1 and the process of Step S1 and the subsequent processes are repeatedly performed.

On the other hand, in Step S2, when it is determined that the switching from the writing mode to the reading mode is not performed, in Step S5, on the basis of the thus obtained mode switching signal, the control micro computer 42 determines whether the switching from the reading mode to the writing mode is performed or not. To be more specific, in a case the current mode is the reading mode and also where the thus obtained mode switching signal includes data indicating that the mode instructed to be switched in response to the operation of the operation unit (not shown) of the host apparatus 25 by the user is the writing mode, it is determined that the switching from the reading mode to the writing mode is performed. On the other hand, in other cases, it is determined that the switching from the reading mode to the writing mode is not performed.

In Step S5, when it is determined that the switching from the reading mode to the writing mode is performed, the control micro computer 42 recognizes in Step S6 that the switching from the reading mode that is the current mode to the writing mode is performed. At the same time, as the necessary laser power during writing mode is relatively higher than that in the reading mode, the control micro computer 42 generates a writing mode voltage switching control signal for supplying predetermined power supply voltage and laser drive voltage with which laser light having the predetermined laser power is output from the laser diode 8 in the writing mode to the laser driver circuit 19 and the laser diode 8, and supplies the thus generated writing mode voltage switching control signal to the power supply regulator 43.

In Step S7, on the basis of the writing mode voltage switching control signal supplied from the control micro computer 42, the power supply regulator 43 supplies the predetermined power supply voltage and laser drive voltage with which laser light having the predetermined laser power is output from the laser diode 8 in the writing mode to the laser driver circuit 19 and the laser diode 8. To be more specific, on the basis of the writing mode voltage switching control signal supplied from the control micro computer 42, the power supply regulator 43 increases the power supply voltage to be output to the entirety of the laser driver circuit 19 which is set in the reading mode before the switching and also increases the laser drive voltage to be applied to the laser diode 8. At the same time, the laser diode driver 41 increases the base-emitter bias voltage of the drive transistor 45. After that, the laser diode driver 41 controls a current flowing through a base terminal of the drive transistor 45 in accordance with the record data (NRZ: the NRZ modulation method) after the modulation process to generate a record waveform.

With this configuration, in conjunction with the mode switching signal, at the same time when the power supply voltage is switched from the reading mode to the writing mode, the mode is shifted to the writing mode. During the writing mode (at the time of the recording), the drive performance of the laser diode driver 41 can be ensured and as a result, it is possible to improve the recording speed and the optical waveform quality.

After that, the process advances to Step S1 and the process of Step S1 and the subsequent processes are repeatedly performed.

In Step S5, when it is determined that the switching from the reading mode to the writing mode is not performed, the control micro computer 42 recognizes in Step S8 that the mode is not switched in a case where the current mode is the writing mode and also where the thus obtained mode switching signal includes data indicating that the mode instructed to be switched in response to the operation of the operation unit (not shown) of the host apparatus 25 by the user is the writing mode when the switching from the writing mode to the writing mode is performed, or, in a case where the current mode is the reading mode and also where the thus obtained mode switching signal includes data indicating that the mode instructed to be switched in response to the operation of the operation unit (not shown) of the host apparatus 25 by the user is the reading mode when the switching from the reading mode to the reading mode is performed.

After that, the process advances to Step S1 and the process of Step S1 and the subsequent processes are repeatedly performed.

According to the embodiment of the present invention, on the basis of the thus obtained mode switching signal, it is determined whether the switching from the writing mode to the reading mode is performed or the switching from the reading mode to the writing mode is performed. When it is determined that the switching from the writing mode to the reading mode is performed, the reading mode voltage switching control signal is generated for supplying the predetermined power supply voltage and laser drive voltage with which the laser light having the predetermined laser power is output from the laser diode 8 in the reading mode to the laser driver circuit 19 and the laser diode 8, and on the basis of the thus generated reading mode voltage switching control signal, the predetermined power supply voltage and laser drive voltage with which the laser light having the predetermined laser power is output from the laser diode 8 in the reading mode are supplied to the laser driver circuit 19 and the laser diode 8. On the other hand, the writing mode voltage switching control signal is generated for supplying the predetermined power supply voltage and laser drive voltage with which the laser light having the predetermined laser power is output from the laser diode 8 in the writing mode, and on the basis of the thus generated writing mode voltage switching control signal, the predetermined power supply voltage and laser drive voltage with which the laser light having the predetermined laser power is output from the laser diode 8 in the writing mode are supplied to the laser driver circuit 19 and the laser diode 8. Thus, it is possible to improve the recording speed and the optical waveform quality while the lower power consumption in the laser driver circuit 19 is achieved.

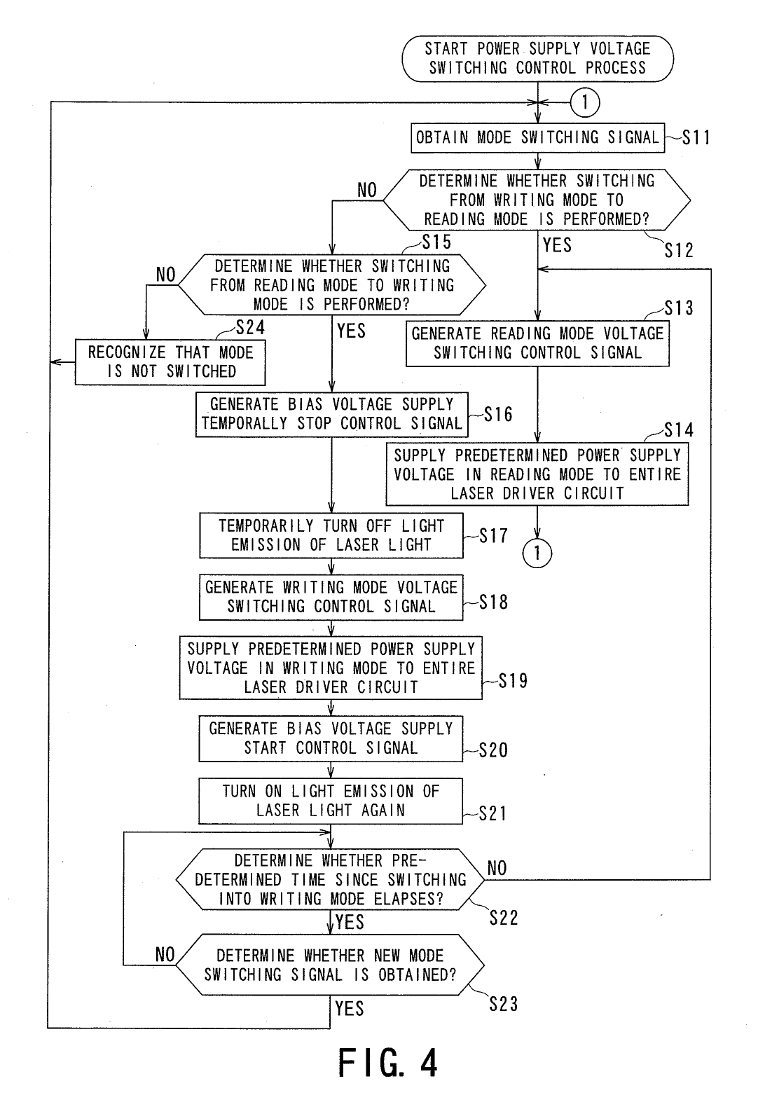

Incidentally, in the power supply voltage switching control process described on the basis of the flowchart of FIG. 4, when the mode is switched from the reading mode to the writing mode, in conjunction with the thus obtained mode switching signal, the power supply voltage output from the power supply regulator 43 and a base-emitter bias voltage of the drive transistor 45 are controlled (for example, the respective voltages are changed stepwise). However, in a case where a laser control band performed by the laser diode driver 41 is narrower than response bands of the power supply voltage output from the power supply regulator 43 and the base-emitter bias voltage of the drive transistor 45, if these voltages are controlled in conjunction with the mode switching signal (for example, the respective voltages are changed stepwise), the laser power involves variations along with a variation in an operational point of the drive transistor 45. As a result, an excess current flows into the laser diode driver 41 and the product life of the laser diode driver 41 is unnecessarily shortened as compared with the original life expectancy.

In view of the above, such a configuration may be adopted that when the control micro computer 42 obtains the mode switching signal for switching from the reading mode to the writing mode from the host apparatus 25 via the interface circuit 24, the light emission of the laser light from the laser diode 8 is temporarily turned OFF, the power supply voltage output from the power supply regulator 43 and the base-emitter bias voltage of the drive transistor 45 is switched so as to correspond to the writing mode, and then the light emission of the laser light from the laser diode 8 is turned ON again. Hereinafter, the power supply voltage switching control process with use of this method will be described.

With reference to a flowchart of FIG. 4, another voltage switching control process in the laser driver circuit 19 of FIG. 2 will be described. It should be noted that the processes in Steps S11 to S15, S18, S19, and S24 of FIG. 4 are similar to those in Steps S1 to S8 of FIG. 3 and a description thereof will be omitted.

In Step S15, when it is determined that the switching from the reading mode to the writing mode is performed, the control micro computer 42 generates in Step S16 a bias voltage supply temporally stop control signal for temporally stopping a supply of a bias-emitter bias voltage of the drive transistor 45 from the laser diode driver 41, and supplies the thus generated bias voltage supply temporally stop control signal to the laser diode driver 41.

In Step S17, on the basis of the bias voltage supply temporally stop control signal supplied from the control micro computer 41, the laser diode driver 41 temporarily stops the supply of the bias-emitter bias voltage of the drive transistor 45 to temporarily turn OFF the light emission of the laser light from the laser diode 8.

After that, the process advances to Step S18. The setting is switched from the reading mode to the writing mode and the predetermined power supply voltage necessary in the writing mode is supplied to the entirety of the laser driver circuit.

In Step S20, the control micro computer 42 generates a bias voltage supply start control signal for starting the supply of the bias-emitter bias voltage of the drive transistor 45 from the laser diode driver 41, and supplies the thus generated bias voltage supply start control signal to the laser diode driver 41.

In Step S21, on the basis of the bias voltage supply start control signal supplied from the control micro computer 41, the laser diode driver 41 starts the supply of the bias-emitter bias voltage of the drive transistor 45 to turn ON the light emission of the laser light from the laser diode 8.

With this configuration, in a case where the laser control band performed by the laser diode driver 41 is narrower than the response bands of the power supply voltage output from the power supply regulator 43 and the base-emitter bias voltage of the drive transistor 45, the excess current is prevented from flowing through the laser diode driver 41 and it is possible to avoid the decrease in the product life of the laser diode driver 41.

In Step S22, the control micro computer 42 determines whether or not a predetermined time previously set since the switching into the writing mode (for example, ten minutes or the like) elapses.

In Step S22, when it is determined that the predetermined time previously set since the switching into the writing mode (for example, ten minutes or the like) does not elapse, the control micro computer 42 determines in Step S23 whether or not a new mode switching signal is obtained.

In Step S23, when it is determined that a new mode switching signal is obtained, the process advances to Step S11, and thereafter, the process of Step S11 and the subsequent processes are repeatedly performed.

In Step S23, when it is determined that a new mode switching signal is not obtained, the process returns to Step S22, and then the process of Step S22 and the subsequent processes are repeatedly performed.

On the other hand, in Step S22, when it is determined that the predetermined time previously set since the switching into the writing mode (for example, ten minutes or the like) elapses, the process advances to Step S13, and thereafter, the process of Step S13 and the subsequent processes are repeatedly performed. That is, in Steps S13 and S14, the setting is switched from the writing mode to the reading mode, and the power supply voltage and the laser drive voltage necessary for the reading mode are supplied to the laser driver circuit 19 and the laser diode 8.

With this configuration, in a case where the instruction for switching from the host apparatus 25 to the writing mode is not issued for a certain period of time (in a case of no recording request), the setting can be switched from the writing mode to the reading mode. As a result, the lower power consumption in the laser driver circuit can be further achieved.

It should be noted that also in a case where the switching is performed from the writing mode to the reading mode, the light emission of the laser light from the laser diode 8 may be temporarily turned OFF. In a case where these voltages are controlled in conjunction with the mode switching signal (for example, the respective voltages are changed stepwise), in general, these voltages are changed in a decreasing direction when the switching is performed from the writing mode to the reading mode, the laser diode may not be temporarily turned OFF as long as the operation of the laser diode driver 41 is not interfered.

Also, on the contrary, in a case where the switching is performed from the reading mode to the writing mode, even when the response bands of the power supply voltage output from the power supply regulator 43 and the base-emitter bias voltage of the drive transistor 45 are narrower than the laser control band performed by the laser diode driver 41, these voltages need to be switched in a further narrower response band than the control band of the laser power when the control band of the laser power is narrow. If these voltages are switched in conjunction with the mode switching signal, after the shift to the writing mode (after the execution of the writing process is started), such a state may occur for some time that the voltage does not reach the predetermined voltage. In the above-mentioned state, a satisfactory recording quality cannot be obtained at the initial stage of the writing.

In view of the above, when the control micro computer 42 obtains the mode switching signal for switching from the reading mode to the writing mode which is supplied from the host apparatus 25 via the interface circuit 24, in prior to the shift into the writing mode, the switching of the power supply voltage in the writing mode may be executed.

Of course, in a case where the switching is performed from the writing mode to the reading mode, as in the shift into the writing mode, after the shift into the writing mode (after the execution of the writing process is started), as it is not assumed in a normal case that the voltage does not reach the predetermined voltage for some time, the switching of the power supply voltage may be behind the mode shift to some extent.

Furthermore, in the laser driver circuit 19 of FIG. 2, the base-emitter bias voltage of the drive transistor 45 is generated and controlled by the laser diode driver 41, but the configuration is not limited to the above. For example, a bias voltage generation unit (not shown) for generating the base-emitter bias voltage of the drive transistor 45 is provided outside the laser diode driver 41. In the bias voltage generation unit, on the basis of the control signal form the mode switching signal or the control micro computer 42, the base-emitter bias voltage of the drive transistor 45 may be generated and controlled.

It should be noted that in the power supply voltage switching control process described on the basis of the flowcharts of FIGS. 3 and 4, both the power supply voltage output from the power supply regulator 43 and the base-emitter bias voltage of the drive transistor 45 are switched in accordance with the mode switching but one of these voltages may be fixed and the other voltage may be switched.

In addition, in the power supply voltage switching control process described on the basis of the flowcharts of FIGS. 3 and 4, as the power supply voltage output from the power supply regulator 43 and the base-emitter bias voltage of the drive transistor 45, two voltages are previously set for the reading mode and the writing mode, and these voltages are switched as appropriate. This method can be realized at a reasonable price as the switching has two types and thus the voltage can be switched by way of an analog switch element or the like.

In recent years, many types of recording media have been proposed, and among them, various recording speeds (multiple higher speeds) are present. In view of the above, for example, the control micro computer 42 determines a type of a recording medium (necessary power for writing) and reads out necessary voltage value corresponding on the basis of the determination result from the ROM 28.

Next, the control signal is supplied from the control micro computer 42 to the power supply regulator 43 and the laser diode driver 41 to switch the power supply voltage output from the power supply regulator 43 and the base-emitter bias voltage of the drive transistor 45. In this case, the number of mode for the power supply voltage output from the power supply regulator 43 does not need to correspond to that for the base-emitter bias voltage of the drive transistor 45. For example, the power supply voltage output from the power supply regulator 43 may be changed depending on the type of the recording medium and a recording strategy to change the power supply voltage in the writing mode, and the base-emitter bias voltage of the drive transistor 45 may be switched only between two types of the reading mode and the writing mode. For a configuration of the laser driver circuit 19 at this time, for example, the control micro computer 42 may include a built-in DA converter to supply the voltage switching control signal to the power supply regulator 43 in a form of an analog voltage value or the power supply regulator 43 may include the built-in DA converter.

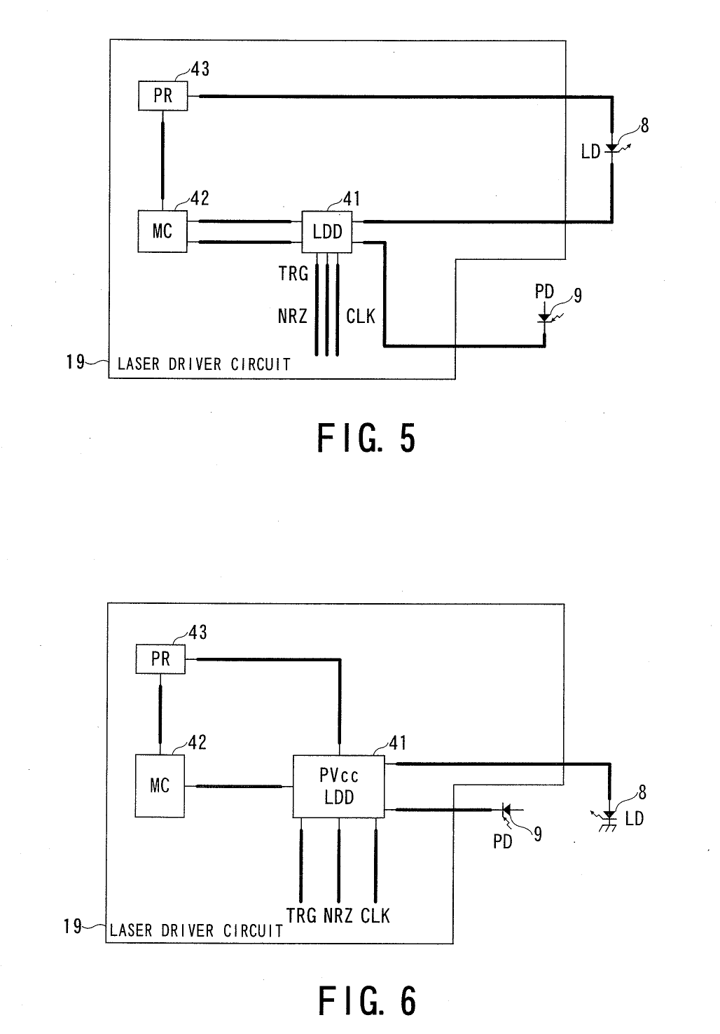

Next, FIG. 5 illustrates another internal circuit configuration of the laser driver circuit 19 of FIG. 1.

In a case of the laser driver circuit 19 of FIG. 5, such a configuration is adopted that a part corresponding to the drive transistor 45 of FIG. 2 is built in the laser diode driver 41.

FIG. 6 illustrates still another internal circuit configuration of the laser driver circuit 19 of FIG. 1.

In an example of FIG. 6, the laser diode 8 has a grounded cathode type configuration. As illustrated in FIG. 6, the laser diode driver 41 is provided with a dedicated power supply PVcc for driving the laser diode 8 other than a power supply for operating an internal circuit of the laser diode driver 41. A laser drive voltage for driving the laser diode 8 is output from the dedicated power supply PVcc.

It should be noted that the power supply for operating the internal circuit of the laser diode driver 41 may double as the dedicated power supply PVcc for driving the laser diode 8.

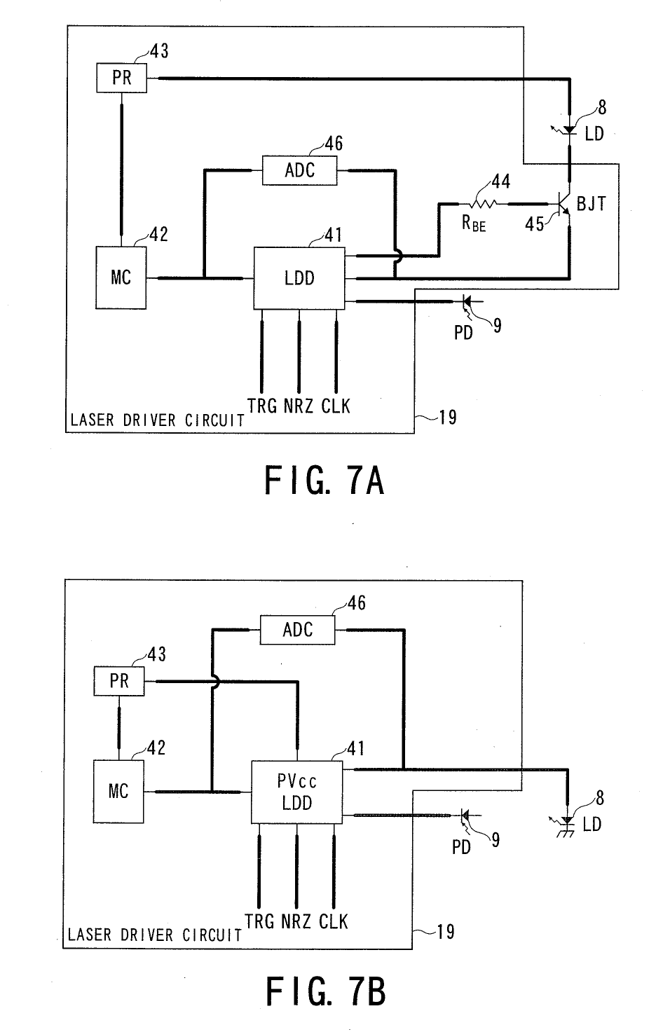

FIGS. 7A and 7B illustrates further internal circuit configurations of the laser driver circuit 19 of FIG. 1. FIG. 7A illustrates the laser diode 8 having a grounded anode type configuration, and FIG. 7B illustrates the laser diode 8 having a grounded cathode type configuration.

In the case of the laser driver circuit 19 in FIGS. 7A and 7B, the power supply voltage output from the power supply regulator 43 and the base-emitter bias voltage of the drive transistor 45 are not previously set, but on the basis of the laser drive voltage of the laser diode 8 measured by an AD converter 46, these voltage can be subsequently set by the control micro computer 42 for the control. It should be noted that the AD converter 46 may be built in the laser diode driver 41 or the control micro computer 42 when necessary.

As a voltage setting method for the control micro computer 42, for example, it is possible to adopt a method of adding two types of fixed values determined at the time of designing for the writing mode and the reading mode with respect to the measured value of the laser drive voltage, a method in which the control micro computer 42 determines the type of the recording medium (power necessary for the writing) and the corresponding necessary voltage value is read out from the ROM 28 for the addition, and other methods.

It should be noted that a high speed current change is applied to the laser diode 8 in the writing mode, and thus it is difficult to measure the instantaneous voltage change. In view of the above, in such a case, the power supply voltage output from the power supply regulator 43 and the base-emitter bias voltage of the drive transistor 45 may be set on the basis of the output value from the AD converter 46 in the reading mode.

Of course, in the configurations of FIG. 7 as well, in accordance with the mode switching, both the power supply voltage output from the power supply regulator 43 and a base-emitter bias voltage of the drive transistor 45 are switched, but also one of these voltages is may be fixed and the other voltage may be switched.

It should be noted that the series of the processes described according to the embodiments of the present invention can be executed by software but also can be executed by hardware.

In addition, according to the embodiments of the present invention, the description has been given of the example where the steps in the flowcharts are executed in the stated order in a time series manner, but a case where the steps are not necessarily executed in the time series manner and are executed in parallel or individually is within the scope of the present invention.

What is claimed is:

1. A laser driver circuit, comprising:
a light emitting unit configured to emit a laser light;
a voltage supply unit configured to supply a predetermined power supply voltage to the laser driver circuit; and
a control unit configured to switch the predetermined power supply voltage supplied from the voltage supply unit to the laser driver circuit in accordance with one of a recording mode or a reproduction mode.

2. The laser driver circuit according to claim 1, wherein the control unit is configured to switch the predetermined power supply voltage supplied from the voltage supply unit to the laser driver circuit on the basis of a switching signal indicating a switching to one of the recording mode or the reproduction mode.

3. The laser driver circuit according to claim 1, wherein the control unit is configured to change the predetermined power supply voltage in accordance with a type of a recording medium and a recording strategy when the predetermined power supply voltage supplied from the voltage supply unit to the laser driver circuit is switched in accordance with the recording mode.

4. The laser driver circuit according to claim 1, wherein the control unit is configured to switch a base ground potential of a drive transistor connected in a cascode to a laser drive IC in the laser driver circuit when the control switches the predetermined power supply voltage supplied from the voltage supply unit to the laser driver circuit in accordance with one of the recording mode or the reproduction mode.

5. The laser driver circuit according to claim 1, wherein the control unit is configured to switch the predetermined power supply voltage supplied from the voltage supply unit to the laser driver circuit in accordance with one of the recording mode or the reproduction mode after a light emission of the laser light performed by the light emitting unit is temporarily turned OFF.

6. The laser driver circuit according to claim 5, wherein the control unit is configured to temporarily turn OFF the light emission of the laser light performed by the light emitting unit when switching from the reproduction mode to the recording mode.

7. The laser driver circuit according to claim 1, further comprising: a measurement unit configured to measure a drive voltage that is a voltage for driving the light emitting unit, wherein the control unit is configured to set the predetermined power supply voltage supplied from the voltage supply unit to the laser driver circuit on the basis of the drive voltage measured by the measurement unit.

8. The laser driver circuit according to claim 7, wherein the measurement unit is an analog-digital converter.

9. An optical disc apparatus having a laser driver circuit, the laser driver circuit comprising:
a light emitting unit configured to emit a laser light;
a voltage supply unit configured to supply a predetermined power supply voltage to the laser driver circuit; and
a control unit configured to switch the predetermined power supply voltage supplied from the voltage supply unit to the laser driver circuit in accordance with one of a recording mode or a reproduction mode.
